(19) United States
(12) Patent Application Publication
(10) Pub. No.: US 2005/0198439 A1
(43) Pub. Date: Sep. 8, 2005

(54) Cache memory prefetcher

(76) Inventors: Fredy Lange, Givat Nili (IL); Zvi Greenfield, Kfar Saba (IL); Alberto Rodrigo Mandler, Rehovot (IL); Avi Plotnik, Ramat Yishay (IL)

Correspondence Address: WOLF GREENFIELD & SACKS, PC;FEDERAL RESERVE PLAZA, 600 ATLANTIC AVENUE, BOSTON, MA, 02210-2211, US

(21) Appl. No.: 10/793,561

(22) Filed: Mar. 4, 2004

(51) Int. Cl. G06F 12/00

(52) U.S. Cl. 711/137

(57) ABSTRACT

A prefetcher performs advance retrieval of data from a main memory, and places the retrieved data in an intermediate memory. The main memory is accessed by vector addressing, in which the vector access instruction includes a main memory address and a direction indicator. Main memory data is cached in an associated cache memory. The prefetcher contains a direction selector and a controller. The direction selector selects a direction of data access according to the direction indicator of a single data access transaction. The direction indicator is supplied by the processor accessing the main memory, and incorporates the processor's internal knowledge of the expected direction of future data accesses. The controller retrieves data items from the main memory, in the direction of access selected by the direction selector, and places the retrieved data items in the intermediate memory.

### FIELD AND BACKGROUND OF THE INVENTION

The present embodiments relate to retrieving a data sequence expected to be required for future data transactions, and, more particularly, for retrieving a data sequence where the sequence is selected for retrieval in accordance with a single access transaction.

Memory caching is a widespread technique used to improve data access speed in computers and other digital systems. Data access speed is a crucial parameter in the performance of many digital systems, and in particular in systems such as digital signal processors (DSPs) which perform high-speed processing of real-time data. Cache memories are small, fast memories holding recently accessed data and instructions. Caching relies on two properties of memory access, known as temporal locality and spatial locality. Temporal locality states that information recently accessed from memory is likely to be accessed again soon. Spatial locality states that accesses to memory are likely to be done in a sequential manner. For example, after executing an instruction from a given memory location, the next instruction the program executes is often stored in the following memory location. The spatial locality principle also holds when long vectors of data are processed, and are accessed from memory in a consecutive sequence.

When an item stored in main memory is required, the processor first checks the cache to determine if the required data or instruction is present in the cache. If so, the data is loaded directly from the cache instead of from the slower main memory, with very little delay. Due to temporal and spatial locality, a relatively small cache memory can significantly speed up memory accesses for most programs.

FIG. 1 illustrates a processing system 100 in which the system memory 110 is composed of both a fast cache memory 120 and a slower main memory 130. When processor 140 requires data from the system memory 110, the processor first checks the cache memory 120. Only if the memory item is not found in the cache memory 120 is the data retrieved from the main memory 130. Thus, data which was previously stored in the cache memory 120 can be accessed quickly, without accessing the slow main memory 130.

Memory accesses for data present in the cache are quick. However, if the data sought is not yet stored in the cache memory, the required data is available only after it is first retrieved from the main memory. Since main memory data access is relatively slow, each first time access of data from the main memory is time consuming. The processor idles while data is retrieved from the main memory and stored in the cache memory.

The delays caused by first time accesses of data are particularly problematic for data that is used infrequently. Infrequently used data will likely have been cleared from the cache between uses. Each data transaction then requires a main memory retrieval, and the benefits of the cache memory are negated. The problem is even more acute for systems, such as DSPs, which process long vectors of data, where each data item is read from memory (or provided by an external agent), processed, and then replaced by new data. In such systems a high proportion of the data is used only once, so that first time access delays occur frequently, and the cache memory is largely ineffective.

Various schemes have been proposed for speeding up memory transactions by speculatively prefetching data from memory before the data is actually required by the processing system. In systems with data prefetching it is assumed that memory accesses will proceed sequentially. Data is therefore retrieved in sequence from the main memory, even though the data has not yet been accessed by the processor. If a later access to the data occurs, the prefetched data is available to the processor without requiring a slow main memory access. Data prefetching is effective when the underlying assumption of sequential accesses is true, for example for accessing instruction sequences from main memory.

Data may be prefetched from the main memory in an ascending or descending sequence. In many cases, even when sequential accesses occur the direction of access is not known. Selecting the incorrect direction for prefetching reduces the effectiveness of data prefetching, since the prefetched data may be discarded before it is required by the processor. Current prefetchers generally prefetch data in a single direction, or rely on a priori knowledge, such as the progress of the instruction sequence, to select a direction. Both these methods are generally not effective for complex systems, in which it is difficult to determine the optimized direction a priori, and particularly in multiple-processor systems where more than processor is accessing the memory system.

An additional prior art technique is to modify the instruction set, so that the direction for prefetch may be specified by the programmer in the instruction. However, working with a non-standard instruction set is cumbersome, and presents difficulties to system designers.

In U.S. Pat. No. 5,692,168 McMahan provides a prefetch buffer using flow control bit to identify changes of flow within the code stream, in order to prefetch instruction bytes to a prefetch buffer. When the transfer of instruction bytes from a current prefetch block is complete, the flow control bit is checked. If the flow control bit is set to indicate that the prefetch clock includes a predicted change-of-flow (COF) instruction, instruction bytes will not be transferred from the next prefetch block unless the predicted COF instruction is confirmed as having been decoded. McMahan's prefetch buffer is suitable only for pre fetching instructions from memory in a predetermined direction, and does not provide a general solution to speeding up access to main memories holding system data. Additionally, McMahan's method is suitable for a single processor system, but is not suitable for multiple processors independently accessing the memory.

In U.S. Pat. No. 6,557,081, Hill et al. present a prefetching control system for a processor. The prefetching queue may include an arbiter, a cache queue and a prefetch queue. The arbiter issues requests including read requests. Responsive to a read request, the cache queue issues a control signal. The prefetch queue receives the control signal and an address associated with the read request. When the received address is a member of a pattern of read requests from sequential memory locations, the prefetch queue issues a prefetch request to the arbiter. Hill's prefetcher can identify multiple parallel sequential read patterns from a sequence of read requests issued by an agent core, and may identify read patterns directed to advancing or retreating locations in memory. However, the prefetcher determines the direction of the sequence by analyzing a pattern of read requests, and therefore requires multiple read accesses before prefetching can be performed.

There is thus a widely recognized need for, and it would be highly advantageous to have, a system and method for making main memory data rapidly available for caching and/or processing, devoid of the above limitations.

### SUMMARY OF THE INVENTION

According to a first aspect of the present invention there is provided a prefetcher which performs advance retrieval of data from a main memory, and places the retrieved data in an intermediate memory. The main memory is accessed by vector addressing, in which the vector access instruction includes a main memory address and a direction indicator. The prefetcher contains a direction selector and a controller. The direction selector selects a direction of data access according to the direction indicator of a single data access transaction. The controller retrieves data items from the main memory, in the direction of access selected by the direction selector, and places the retrieved data items in the intermediate memory.

According to a second aspect of the present invention there is provided a memory system containing a main memory for storing data items, a cache memory, and a prefetcher. The main memory is accessible by a vector access command, which includes a main memory address and a direction indicator. The cache memory serves for caching main memory data. The prefetcher contains a direction selector and a controller, which together perform advance retrieval of data from a main memory, and place the retrieved data in an intermediate memory. The direction selector selects a direction of data access according to the direction indicator of a single data access transaction. The controller retrieves data items from the main memory, in the direction of access selected by the direction selector, and places the retrieved data items in the intermediate memory.

According to a third aspect of the present invention there is provided a processing system containing a processor for performing memory accesses, a main memory for storing data items, a cache memory, and a prefetcher. The processor accesses the main memory. The main memory is accessible by a vector access command, which includes a main memory address and a direction indicator. The cache memory serves for caching main memory data. The prefetcher contains a direction selector and a controller, which together perform advance retrieval of data from a main memory, and place the retrieved data in an intermediate memory. The direction selector selects a direction of data access according to the direction indicator of a single data access transaction. The controller retrieves data items from the main memory, in the direction of access selected by the direction selector, and places the retrieved data items in the intermediate memory.

According to a fourth aspect of the present invention there is provided a prefetcher which performs advance retrieval of data from a main memory, and places the retrieved data in an intermediate memory. The main memory is accessed by indirect addressing. The prefetcher contains a direction selector and a controller. The direction selector selects a direction of data access according to the modifier of a single data access transaction. The controller retrieves data items from the main memory, in the direction of access selected by the direction selector, and places the retrieved data items in the intermediate memory.

According to a fifth aspect of the present invention there is provided a memory system containing a main memory for storing data items, a cache memory, and a prefetcher. The main memory is accessed by indirect addressing. The cache memory serves for caching main memory data. The prefetcher contains a direction selector and a controller, which together perform advance retrieval of data from a main memory, and place the retrieved data in an intermediate memory. The direction selector selects a direction of data access according to the modifier of a single data access transaction. The controller retrieves data items from the main memory, in the direction of access selected by the direction selector, and places the retrieved data items in the intermediate memory.

According to a sixth aspect of the present invention there is provided a processing system containing a processor for performing memory accesses, a main memory for storing data items, a cache memory, and a prefetcher. The main memory is accessed by indirect addressing. The cache memory serves for caching main memory data. The prefetcher contains a direction selector and a controller, which together perform advance retrieval of data from a main memory, and place the retrieved data in an intermediate memory. The direction selector selects a direction of data access according to the direction modifier of a single data access transaction. The controller retrieves data items from the main memory, in the direction of access selected by the direction selector, and places the retrieved data items in the intermediate memory.

According to a seventh aspect of the present invention there is provided a method for retrieving data from a main memory accessed by a vector access command. The access command contains a main memory address and a direction indicator. First, a data access instruction is received from a processing agent, and the cache hit/miss response of an associated cache memory to the instruction is determined. If a cache miss occurred, a direction of access is selected in accordance with the direction indicator contained within the access command, and data items are retrieved from the main memory in the selected direction of access.

According to an eighth aspect of the present invention there is provided a method for retrieving data from a main memory accessed by indirect addressing. First, a data access instruction is received from a processing agent, and the cache hit/miss response of an associated cache memory to the instruction is determined. If a cache miss occurred, a direction of access is selected in accordance with the modifier of the indirect address access command, and data items are retrieved from the main memory in the selected direction of access.

The present invention successfully addresses the shortcomings of the presently known configurations by providing a prefetcher which selects a prefetch direction on the basis of a single read access. The prefetcher selects a direction on the basis of a direction indicator (or modifier), which is supplied by the processor accessing the main memory. The direction indicator incorporates the processor's internal knowledge of the expected direction of future data accesses.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

Implementation of the method and system of the present invention involves performing or completing selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the Drawings

FIG. 1 shows a prior art processing system having a system memory composed of both a fast cache memory and a slower main memory.

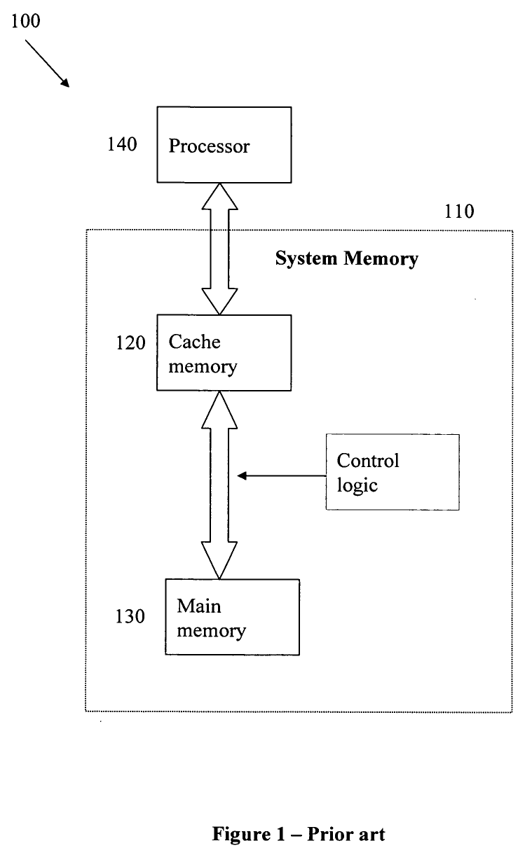

FIG. 2 is a simplified block diagram of a prefetcher for vector addressing, according to a preferred embodiment of the present invention.

FIG. 3 is a simplified block diagram of a controller, according to a preferred embodiment of the present invention.

FIG. 4 is a simplified block diagram of a prefetcher for indirect addressing, in accordance with a further preferred embodiment of the present invention.

FIG. 5 is a simplified flowchart of a method for prefetching data from a main memory, in accordance with a preferred embodiment of the present invention.

FIG. 6 is a simplified flowchart of a method for retrieving a sequence of data items from a main memory, according to a preferred embodiment of the present invention.

### DESCRIPTION OF THE PREFERRED EMBODIMENTS

The present embodiments are of a prefetcher which selects the direction of prefetch from a single data access transaction. Once the prefetch direction is selected, data items can be prefetched from memory in preparation for expected future data access transactions. Specifically, the present embodiments can be used to determine the address of the next data item to be prefetched by incrementing or decrementing the address of a prefetched data item in the selected prefetch direction.

The principles and operation of a prefetcher according to the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

In many cases, when a memory access is performed the address of the next required data item is known with a high probability. Memory accesses often occur sequentially, as when instructions or blocks of data are retrieved from memory. Often, the expected direction of access is based on information present in the processing agent accessing the memory. Additionally, the system designer may have other knowledge of whether data access is sequential, and, if so, of the direction of the data access sequence. The present embodiments utilize the processor knowledge to provide a prefetcher with a direction of access for prefetching data items.

The present embodiments are of a system and method for prefetching data that is not currently known to be required by the system but rather is expected to be required by following memory transactions (denoted herein speculative data). The speculative data is read from main memory, and stored in a fast intermediate memory device and/or cached, without interfering with other memory system activities. If the stored speculative data is required, the data is readily available for processing. Since the prefetcher preferably works in the background, prefetching data does not interfere with other, higher priority, memory accesses.

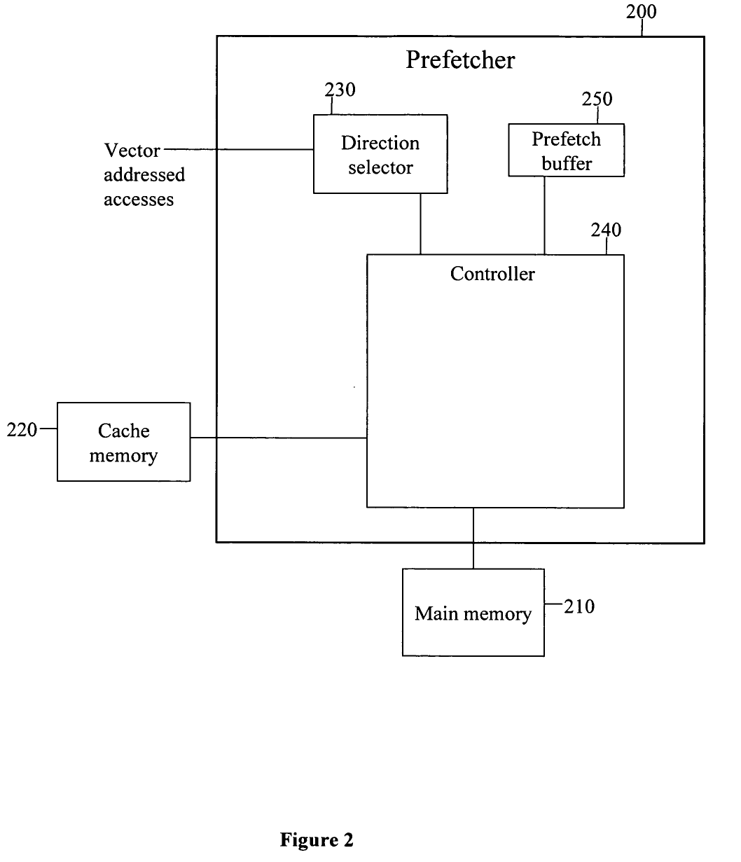

Reference is now made to FIG. 2, which is a simplified block diagram of a prefetcher, according to a preferred embodiment of the present invention. Prefetcher 200 retrieves speculative data from a main memory 210. Main memory 210 is accessed by one or more processing agents, using the vector addressing scheme described below. Main memory 210 can be for storage of data, of instructions, or can be a unified memory for storage of both data and instructions in a single memory device. A main memory data item may consist of a single word or of multiple words. Cache memory 220 serves for caching data from main memory 210. Prefetcher 200 consists of direction selector 230 and controller 240. Direction selector 230 determines the expected direction of data access from a given data access transaction, as described below. Controller 240 retrieves data items sequentially from main memory 210, in the direction selected by direction selector 230, without awaiting an actual data access by the processor to the data items. Controller 240 also stores the retrieved items in an intermediate memory.

In the preferred embodiment, main memory 210 is accessed by a vector addressing scheme. A vector access instruction contains a main memory address to be accessed and a direction indicator. The direction indicator may indicate a forward direction of access, backward direction of access, or no direction of access. The direction specified in the vector address is based on knowledge present within the processing agent accessing main memory 210. For example, a processor which is processing a sequence of instructions accesses main memory addresses in sequence, in a known direction. The processor can include the known direction in the vector access command. If the processor does not have current knowledge of the direction of access, the vector address may not specify a direction of access.

In a second example, the direction of data access is determined by the processor accessing the main memory. A direct memory access device (DMA) may always access data in a single direction, which is generally selected at startup. The DMA can thus provide the selected direction in the vector address. The access direction may also depend on the type of processing agent that issued the current instruction, as with a sequencer which accesses the memory in a single, predetermined direction.

The present embodiments select a direction of access for prefetching, by examining the direction indicator of a single memory access transaction. The data transactions may originate with a processor or other processing agent, such as a sequencer. Data accesses are discussed below as originating with a processor, but may come from one or more agents with memory access capabilities.

Direction selector 230 selects a direction of memory access associated with a single data access transaction. Direction selector 230 uses the direction indicator associated with an instruction to select access direction. Preferably, if no direction of access is selected the current prefetch process continues without interruption. Preferably, the direction indicator is specified as part of the instruction. In an alternate preferred embodiment, the direction indicator is stored in a register.

Preferably, direction selector 230 establishes the access direction whenever a cache miss is detected. When a cache hit is obtained, it is likely that sequential data was prefetched when the currently data item was originally accessed. It may therefore be undesirable to interrupt the current prefetch sequence in order to retrieve main memory data which has already been prefetched. Selecting the direction only when a cache miss is detected is particularly useful in systems where more than one processing agent accesses the memory, to prevent conflicts between processing agents. Direction selector 230 may also determine the direction of access when a processing agent is initialized or reset. Alternately, direction selector 230 may determine the direction of access for each data access transaction.

In the preferred embodiment, prefetcher 200 contains prefetch buffer 250, which is an intermediate memory capable of storing one or more data items. Prefetched data is stored by controller 240 in prefetch buffer 250, along with an indicator of the main memory address associated with the data. Preferably, when a data access transaction is received from the processor, the prefetch buffer is checked to determine if the accessed data item is present. If present, the accessed data item is output to the memory system data bus and/or cached in cache memory 220. If the prefetched data is not required by the processor, it is simply replaced in prefetch buffer 250 when new data is prefetched.

Preferably, prefetch buffer 250 consists of more than one section. When one of the prefetch buffer sections is accessed, controller 250 can continue to store prefetched data in the other prefetch buffer sections. For example, controller 240 may select a prefetch buffer section whenever a new prefetch sequence is begun. The data from previous prefetch sequences may thus be retained in other prefetch buffer sections, even while new data is being prefetched. Thus, although the data stored in a given prefetch buffer section is sequential, the data in the different sections may be from noncontiguous areas of the main memory. Additionally, in a page-structured main memory when prefetcher 200 reaches the end of the current main memory page, data continues to be prefetched from the following page (either the preceding or following page, depending upon the prefetch direction). In a single page prefetcher, the data stored in the page is invalidated as soon as the locator is updated to a new main memory page. In a multi-page prefetcher, the data from the following main memory page can be stored in a different prefetcher page, and the older data remains valid.

In the preferred embodiment, after retrieving the data from main memory 210, controller 240 caches the prefetched data in cache memory 220. When prefetcher 200 contains a prefetch buffer, prefetched data may be stored in cache memory 220 only when actually required by the processor. Caching data only when the data is required may prevent unnecessarily replacing cached data with unneeded prefetched data.

Preferably, the vector address includes additional parameters, which are used by prefetcher 200 to establish one or more additional prefetch characteristics, such as prefetch increment and cacheability.

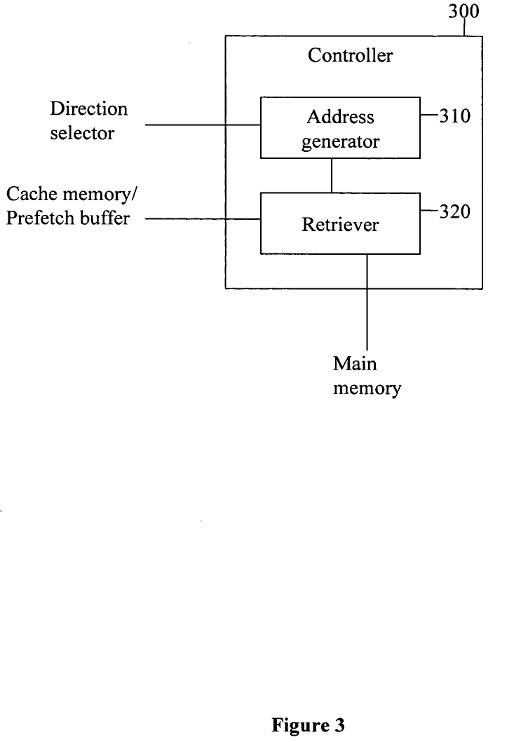

Reference is now made to FIG. 3, which shows a simplified block diagram of a controller, according to a preferred embodiment of the present invention. Controller 300 prefetches the data from the main memory. In the preferred embodiment, the controller consists of address generator 310 and retriever 320. Address generator 310 generates the main memory address of the next data item to be prefetched, and retriever 320 retrieves the data item at from the address generated by address generator 310.

In the preferred embodiment, address generator 310 generates addresses in sequence. When an access instruction is received, address generator 310 determines the address of the data item associated with the current instruction. The current address may be obtained in any manner consistent with the addressing scheme. Address generator 310 generates the address of the data item to be prefetched by incrementing or decrementing the current address by the specified step, according to the access direction specified by the direction selector. Address generator 310 continues to increment (or decrement) the prefetch address until a new prefetch sequence is initiated, generally in response to a cache miss. The increment step may be specified as part of the vector address, may be predefined, may be specified by a special command, or may be stored in a specified register. Additionally, the increment step may depend upon the processing agent which issued the access instruction.

In the preferred embodiment, a new prefetch sequence is initiated whenever a cache miss is detected. Preferably, address generator 310 generates the address of the first data item in the sequence by incrementing (or decrementing) the main memory address accessed by the current instruction, and proceeds sequentially in the direction of access.

Retriever 320 receives the address of the next data item for prefetch from address generator 310, and retrieves the data item from memory. Preferably, retriever 320 stores the retrieved data item in the prefetch buffer. In the preferred embodiment, if uninterrupted by a new cache miss, retriever 320 continues the current prefetch sequence until the prefetch buffer is full.

In the preferred embodiment, the prefetcher is part of a memory system which further contains a cache memory and/or a main memory. The memory system functions as a unit to provide data to a processor, and to other processing agents such as a direct memory access (DMA) device. Preferably the memory system has transaction-pipelined access of memory data.

The main memory may consist of any memory device with the required storage capacity, including a DRAM or EDRAM. The main memory may be for data storage, for instruction storage, or for unified storage of both data and instructions.

In a still further preferred embodiment, the prefetcher is part of a processing system, which further contains a processor, and may contain a cache memory, a main memory, and/or additional processing agents.

The following preferred embodiments provide a prefetcher for a main memory accessed by indirect addressing. Indirect addressing schemes incorporate the processor's internal knowledge of the expected access direction within the memory access command. Indirect addressing is similar to the vector addressing described above, with the distinction that the address of the data item being accessed is not part of the access instruction, but is instead stored in a pointer. The processor indicates the expected direction of access in a modifier, which indicates whether the stored address should be incremented, decremented, or left unchanged. However the modifier is simply used to modify the memory address stored in the pointer, but does not actually carry out prefetching.

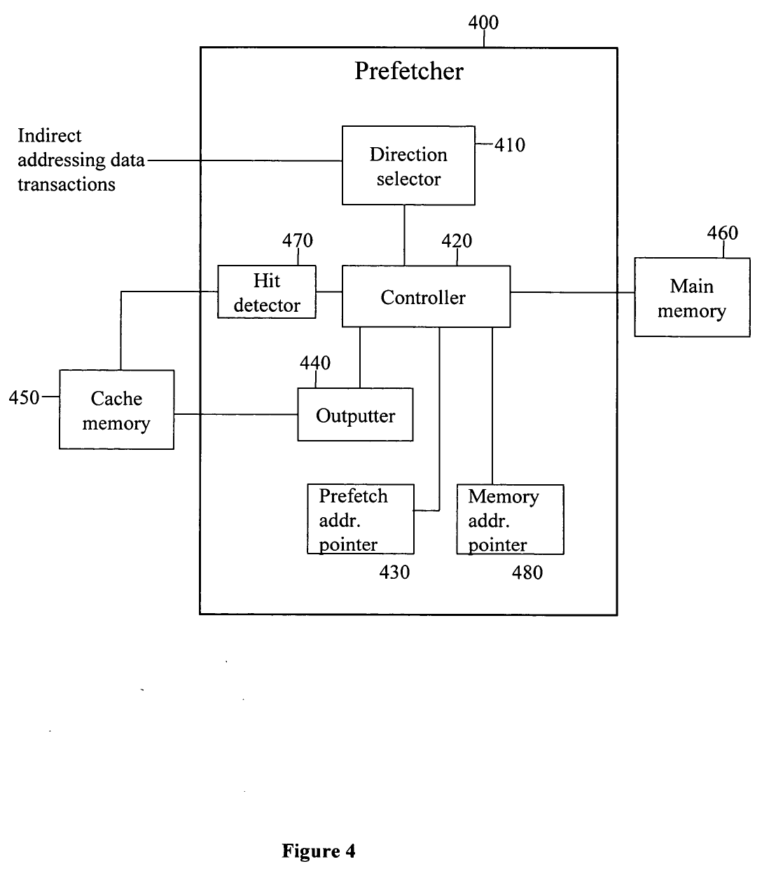

Reference is now made to FIG. 4, which is a simplified block diagram of a prefetcher for a main memory accessed by indirect addressing, in accordance with a preferred embodiment of the present invention. Prefetcher 400 contains direction selector 410 and controller 420, which operate as described above. Prefetcher 400 additionally contains at least one of: prefetch address pointer 430, outputter 440, hit detector 470, and memory address pointer 480. Main memory 460 is accessed by indirect addressing. The indirect addressing may be a post-modify or a pre-modify scheme. Note that the preferred embodiment of FIG. 4 is applicable to the vector addressing scheme described above, with the modification that the main memory address being accessed is specified in the memory access command, rather than memory address pointer 480, and that the direction of access is specified in the access command by a direction indicator, rather than a modifier.

Direction selector 410 selects a direction of memory access associated with a single data access transaction. Direction selector 240 uses the modifier associated with an instruction to select access direction. The modifier may indicate a forward direction of access, backward direction of access, or no direction of access. Preferably, if no direction of access is selected the current prefetch process continues without interruption. The modifier may be specified as part of the instruction or stored in a register.

Preferably, prefetcher 400 contains prefetch address pointer 430, which stores the main memory address of the currently retrieved data item. Controller 420 may use prefetch address pointer 430 to generate subsequent prefetch addresses.

In the preferred embodiment, prefetch controller 420 contains outputter 440 which outputs prefetched data. The data may be output to the memory data bus, and/or to a buffer, and/or to cache memory 450. In systems with a prefetch buffer, outputter 440 first checks for a prefetch buffer hit, and, if a prefetch hit is obtained, outputs the data stored in the prefetch buffer.

Preferably, controller 420 accesses main memory data in the background, thereby not slowing down the memory system. Controller 420 may determine whether a data item is already present in the prefetch buffer before retrieving the item from main memory 460, and retrieve only data items that are missing from the prefetch buffer, thus avoiding unnecessary main memory accesses.

Preferably prefetcher 400 contains hit detector 470, which notifies direction selector 410 whenever a cache hit occurs.

Preferably, prefetcher 400 contains memory address pointer 480, which stores the main memory address of the currently accessed data item.

In the preferred embodiment, the data is read from main memory 460 by an external memory system component, and provided to controller 420 by the external component.

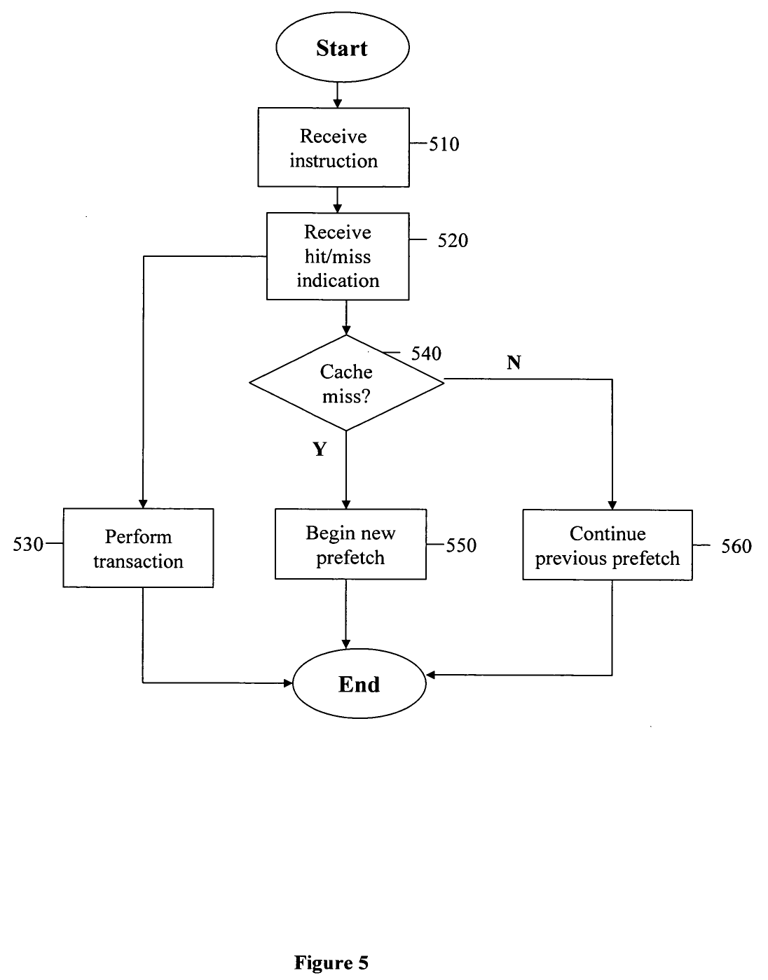

Reference is now made to FIG. 5, which is a simplified flowchart of a method for prefetching data from a main memory, according to a preferred embodiment of the present invention. The main memory is associated with a cache memory which serves for caching main memory data. The present embodiment selects a direction for prefetching data when a cache miss occurs. The selection process does not require knowledge of previous data accesses. The present embodiment applies to both a main memory with vector addressing and to a main memory with indirect addressing.

In step 510 a data access instruction is received from a processing agent. The resulting cache hit or miss response is received in step 520. The transaction is executed in step 530. The data prefetch process is performed in steps 540-570, in parallel with (and preferably in the background to) the data transaction. If a cache miss is detected in step 540, a new prefetch sequence is begun in step 550, as described below. If a cache hit is detected in step 540, the previous prefetch process is continued in step 560. The current prefetch sequence may be ended when a new cache miss occurs, when a prefetch buffer is full, or under other specified conditions.

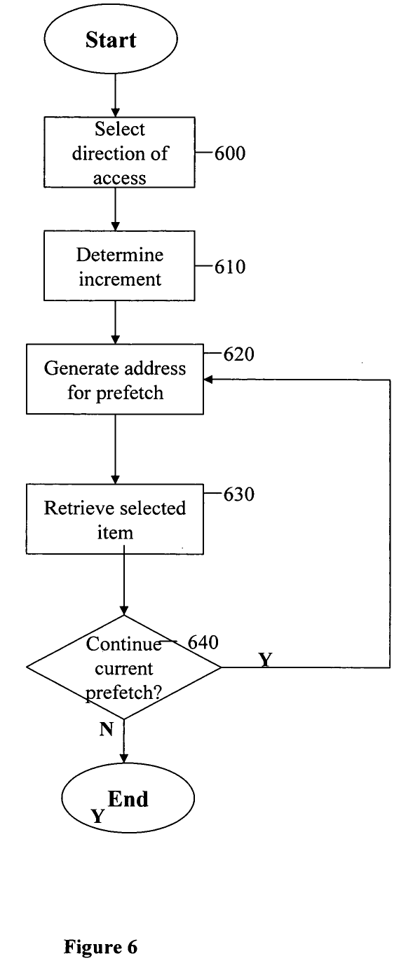

Reference is now made to FIG. 6, which is a simplified flowchart of a method for retrieving a sequence of data items from a main memory, according to a preferred embodiment of the present invention. The method begins when a new prefetch sequence is initiated (step 550 of FIG. 5). In step 600, a direction of access is selected. The direction of access selected is based on parameters associated with the received instruction, as described above. In a first preferred embodiment, the main memory is accessed by vector addressing, and the direction selection is based on the direction indicator. In a second preferred embodiment, the main memory is accessed by indirect addressing, and the direction selection is based on the modifier.

In step 610, the address increment for the prefetch sequence is selected. The increment may be pre-specified, determined from a parameter provided by the access instruction, or associated with a processing agent. The address of the next prefetch sequence data item is generated in step 620. In the preferred embodiment, the address of the first data item in the prefetch sequence is generated by incrementing (or decrementing) the address of the transaction which caused the cache miss by the selected increment, in the direction of access. In step 630, the data item at the generated address is retrieved from the main memory. In step 640 it is determined whether to continue with the current sequence, or begin a new prefetch sequence. If the current sequence is continued, the next address is generated in step 620, by adding or subtracting the specified increment to the address of the previously prefetched data item. Otherwise, the method ends.

In the preferred embodiment, a new direction and/or starting address for the prefetch sequence is selected when an access transaction results in a cache miss. Other embodiments are possible, using additional criteria to determine when a new prefetch sequence should be initiated.

In the preferred embodiment, one or more prefetch sequence characteristics are determined from a parameter associated with the data transaction. The prefetch parameters may include increment and cacheability. Prefetch direction selection may further be based on the type or identity of the processing agent accessing the memory.

Preferably, the method contains the further steps of storing retrieved data items in a prefetch buffer, and/or caching the retrieved data items in the cache memory.

Memory accesses which are performed by indirect accessing may be either pre- or post-modify.

The prefetcher embodiments presented above select a prefetch direction from a single memory access instruction. Prefetching can thus be initiated without further delay, and without performing potentially complex analyses of access sequences. Additionally, selecting a prefetch direction independently for each memory access makes the current embodiments effective for multiple-processor systems, where the various processors may be accessing the memory in different directions. The current embodiments are also effective for selecting other attributes of the prefetch sequence, such as increment and cacheability.

It is expected that during the life of this patent many relevant addressing schemes, pointer, modifier, memory systems, memories, cache memories, buffers, processors, and processing systems will be developed and the scope of the term addressing scheme, pointer, modifier, memory system, memory, cache memory, buffer, processor, and processing system, and transaction pipeline is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A prefetcher for advance retrieval of data from a main memory and placing in an intermediate memory for rapid access by a processor, for a main memory accessible by an access command, said access command comprising a main memory address, said prefetcher comprising:
a direction selector, for selecting for a single access command a direction of data access in said main memory in accordance with a direction indicator associated with said access command, said direction indicator imparting a vector property to said access command thereby to form a vector access command; and
a controller associated with said direction selector, for retrieving data items from said main memory in said selected direction, and placing in said intermediate memory.

2. A prefetcher according to claim 1, wherein said vector access command further comprises a prefetch step, and wherein said controller is further operable to retrieve said data items at address increments equal to said prefetch step.

3. A prefetcher according to claim 1, wherein said direction selector is operable to perform said selecting upon occurrence of a cache miss.

4. A prefetcher according to claim 1, wherein said controller is operable to perform said retrieving in the background to general memory operations.

5. A memory system comprising:
a main memory for storing data items, accessible by a vector access command, said vector access command comprising a main memory address and a direction indicator;
a cache memory, for caching main memory data; and
a prefetcher associated with said main memory and said cache memory, for advance retrieval of data from a main memory and placing in an intermediate memory for rapid access by a processor, comprising:
a direction selector, for selecting for a single vector access command a direction of data access in said main memory in accordance with the associated direction indicator; and
a controller, for retrieving data items from said main memory in said selected direction, and placing in said intermediate memory.

6. A processing system comprising:
a processor;
a main memory for storing data items, accessible by a vector access command, said vector access command comprising a main memory address and a direction indicator;
a cache memory, for caching main memory data for rapid access by said processor; and
a prefetcher associated with said processor, said main memory, and said cache memory, for advance retrieval of data from a main memory and placing in an intermediate memory for rapid access by said processor, comprising:
a direction selector, for selecting for a single vector access command a direction of data access in said main memory in accordance with the associated direction indicator; and
a controller, for retrieving data items from said main memory in said selected direction, and placing in said intermediate memory.

7. A prefetcher for advance retrieval of data from a main memory and placing in an intermediate memory for rapid access by a processor, for a main memory accessible by indirect addressing, said prefetcher comprising:
a direction selector, for selecting a direction of data access in said main memory in accordance with a modifier associated with a single data access transaction; and
a controller associated with said direction selector, for retrieving data items from said main memory in said selected direction, and placing in said intermediate memory.

8. A prefetcher according to claim 7, wherein said intermediate memory comprises a prefetch buffer, for storing at least one retrieved data item.

9. A prefetcher according to claim 7, wherein said controller is further operable to cache said retrieved data items in said cache memory.

10. A prefetcher according to claim 7, wherein data transactions are associated with processing agents, wherein each processing agent has a type, and wherein said direction selector is further operable to select said direction in accordance with the type of a respective processing agent associated with said single data transaction.

11. A prefetcher according to claim 7, wherein data transactions are associated with processing agents, wherein each processing agent has a type, and wherein said direction selector is further operable to select said direction in accordance with the identity of a respective processing agent associated with said single data transaction.

12. A prefetcher according to claim 7, wherein said direction selector is operable to perform said selecting for each of a plurality of data access transactions.

13. A prefetcher according to claim 7, wherein said direction selector is operable to perform said selecting upon initialization of a processing agent operable to access said main memory.

14. A prefetcher according to claim 7, further comprising a hit detector for giving hit and miss indications for data stored in said cache memory.

15. A prefetcher according to claim 14, wherein said direction selector is operable to perform said selecting upon occurrence of a cache miss.

16. A prefetcher according to claim 7, further comprising a prefetch address pointer, for storing a memory address associated with a currently retrieved data item.

17. A prefetcher according to claim 7, wherein said indirect addressing comprises post-modify addressing.

18. A prefetcher according to claim 7, wherein said indirect addressing comprises pre-modify addressing.

19. A prefetcher according to claim 7, wherein said controller comprises:
an address generator, for generating a main memory address of a data item for retrieval in accordance with a previous address and said selected direction; and
a retriever, for retrieving a main memory data item from said main memory at said generated address.

20. A prefetcher according to claim 19, wherein said generating comprises modifying an address of a selected data item by a specified increment in said direction of access.

21. A prefetcher according to claim 20, wherein said selected data item comprises a currently accessed data item.

22. A prefetcher according to claim 20, wherein said selected data item comprises a currently prefetched data item.

23. A prefetcher according to claim 20, wherein said address generator is further operable to determine said increment from said modifier of said single data transaction.

24. A prefetcher according to claim 19, wherein said address generator is further operable to determine a prefetch parameter from said modifier of said single data transaction.

25. A prefetcher according to claim 22, wherein said address generator is operable to determine said increment from an increment register.

26. A prefetcher according to claim 22, wherein said increment comprises a predetermined value.

27. A prefetcher according to claim 7, wherein said main memory is accessible by multiple processing agents.

28. A prefetcher according to claim 7, wherein said controller is operable to perform said retrieving in the background to general memory operations.

29. A memory system comprising:
a main memory, accessible by indirect addressing, for storing data items;
a cache memory, for caching main memory data; and
a prefetcher associated with said main memory and said cache memory, for advance retrieval of data from a main memory and placing in an intermediate memory for rapid access by a processor, comprising:
a direction selector, for selecting a direction of data access in said main memory in accordance with a modifier associated with a single data access transaction; and
a controller, for retrieving data items from said main memory in said selected direction, and placing in said intermediate memory.

30. A memory system according to claim 29, wherein said intermediate memory comprises a prefetch buffer, for storing at least one retrieved data item.

31. A memory system according to claim 29, wherein said direction selector is further operable to select said direction in accordance with at least one of: a type of a respective processing agent associated with said single data transaction, and an identity of a respective processing agent associated with said single data transaction.

32. A memory system according to claim 29, wherein said direction selector is operable to perform said selecting upon occurrence of a cache miss.

33. A memory system according to claim 29, wherein said indirect addressing comprises post-modify addressing.

34. A memory system according to claim 29, wherein said indirect addressing comprises pre-modify addressing.

35. A memory system according to claim 29, wherein said controller comprises:
an address generator, for generating a main memory address of a data item for retrieval in accordance with a previous address and said selected direction; and
a retriever, for retrieving a main memory data item from said main memory at said generated address.

36. A memory system according to claim 35, wherein said generating comprises modifying an address of a selected data item by a specified increment in said direction of access.

37. A memory system according to claim 35, wherein said address generator is operable to determine a prefetch parameter from said modifier of said single data access transaction.

38. A memory system according to claim 29, wherein said controller is operable to perform said retrieving in the background to general memory operations.

39. A processing system comprising:
a processor;
a main memory, accessible by indirect addressing, for storing data items;
a cache memory, for caching main memory data for rapid access by said processor; and
a prefetcher associated with said processor, said main memory, and said cache memory, for advance retrieval of data from a main memory and placing in an intermediate memory for rapid access by said processor, comprising:
a direction selector, for selecting a direction of data access in said main memory in accordance with a modifier associated with a single data access transaction; and
a controller, for retrieving data items from said main memory in said selected direction, and placing in said intermediate memory.

40. A processing system according to claim 39, wherein said intermediate memory comprises a prefetch buffer, for storing at least one retrieved data item.

41. A processing system according to claim 39, wherein said direction selector is operable to perform said selecting upon occurrence of a cache miss.

42. A processing system according to claim 39, wherein said indirect addressing comprises post-modify addressing.

43. A processing system according to claim 39, wherein said controller comprises:
an address generator, for generating a main memory address of a data item for retrieval in accordance with a previous address and said selected direction; and
a retriever, for retrieving a main memory data item from said main memory at said generated address.

44. A processing system according to claim 43, wherein said generating comprises modifying an address of a selected data item by a specified increment in said direction of access.

45. A processing system according to claim 44, wherein said selected data item comprises a currently prefetched data item.

46. A processing system according to claim 43, wherein said address generator is further operable to determine a prefetch parameter from said modifier of said single data access transaction.

47. A processing system according to claim 39, wherein said controller is operable to perform said retrieving in the background to general memory operations.

48. A method for retrieving data from a main memory accessible by an access command, said access command comprising a main memory address, comprising:
receiving a data access instruction from a processing agent;
receiving a cache hit/miss response of a cache memory associated with said main memory to said instruction; and
if said response comprises a cache miss, performing:
selecting a direction of access of said main memory in accordance with a direction indicator contained within said access command; and
retrieving data items from said main memory in said selected direction of access.

49. A method for retrieving data from a main memory accessible by indirect addressing, comprising:
receiving a data access instruction from a processing agent;
receiving a cache hit/miss response of a cache memory associated with said main memory to said instruction; and
if said response comprises a cache miss, performing:
selecting a direction of access of said main memory in accordance with a modifier associated with said instruction; and
retrieving data items from said main memory in said selected direction of access.

50. A method for retrieving data from a main memory according to claim 49, wherein said retrieving comprises:
determining an address increment;
selecting an initial prefetch address; and
while a current prefetch sequence continues, sequentially retrieving main memory data items in said determined increments.

51. A method for retrieving data from a main memory according to claim 50, wherein said initial prefetch address comprises a main memory address adjacent to the address associated with said received data access instruction, in said direction of access.

52. A method for retrieving data from a main memory according to claim 49, further comprising storing a retrieved data item in a prefetch buffer.

53. A method for retrieving data from a main memory according to claim 49, further comprising caching a retrieved data item in said cache memory.

54. A method for retrieving data from a main memory according to claim 49, wherein said selecting is further performed in accordance with at least one of: a type of said processing agent, and an identity of said processing agent.

55. A method for retrieving data from a main memory according to claim 49, wherein said selecting is performed upon occurrence of a cache miss.

56. A method for retrieving data from a main memory according to claim 49, wherein said main memory is accessible by post-modify addressing.

57. A method for retrieving data from a main memory according to claim 49, further comprising generating a main memory address of a data item for retrieval.

58. A method for retrieving data from a main memory according to claim 57, wherein said generating comprises modifying an address of a selected data item by a specified increment in said direction of access.

59. A method for retrieving data from a main memory according to claim 49, further comprising determining a prefetch parameter from said modifier of said data access transaction.

60. A method for retrieving data from a main memory according to claim 57, wherein said retrieving is performed in the background to general memory operations.
